(19) United States
(12) Patent Application Publication
(10) Pub. No.: US 2004/0113736 A1
(43) Pub. Date: Jun. 17, 2004

(54) Electrical transformer apparatus

(76) Inventor: Paul Louis Schimel, Allen, TX (US)

Correspondence Address: TEXAS INSTRUMENTS INCORPORATED, P O BOX 655474, M/S 3999, DALLAS, TX, 75265

(21) Appl. No.: 10/320,121

(22) Filed: Dec. 16, 2002

(51) Int. Cl. H01F 38/20

(52) U.S. Cl. 336/174

(57) ABSTRACT

An electrical transformer apparatus includes: (a) an electrically conductive hollow rod having a continuous via extending from a first end to a second end; (b) an elongate electrically conductive member traversing the via at least one time; and (c) at least one ferrous member substantially surrounding a portion of the rod.

### BACKGROUND OF THE INVENTION

The present invention is directed to electrical transformers, and especially to electrical transformers configured advantageously for use in miniature power converters.

There is a trend in today's marketplace toward smaller products having high quality. This emphasis on compactness and quality necessarily extends to components employed in those products. Many products employ DC-to-DC power converter apparatuses in their circuitry; and power converter devices employ transformers in their construction. Hence, there is a need for a miniature transformer apparatus having high reliability in operation. Preferably such a transformer apparatus may be configured for surface mounting within associated circuitry to facilitate miniaturization of products within which it is used. In its most preferred embodiment, the transformer apparatus is easily configured for a variety of mounting techniques, including surface mounting, through-hole mounting or other mounting techniques, with little change in its fundamental design.

Miniaturized transformer apparatuses have been available in the electronics industry. However, in designing the transformers for compactness to accommodate miniaturization of products employing the transformers the transformers have been fashioned using planar magnetics. In planar magnetic construction, magnetic components of a transformer are arrayed upon a planar substrate, thereby achieving a low profile configuration for the transformer apparatus. Such planar magnetics commonly exhibit lossy characteristics chiefly because of limitations imposed on dimensions for a magnetic core structure and its windings, such as a centrally located core, because of requirements for compact design. Other design inefficiencies for such planar-magnetic transformer designs include, for example, poor ventilation to remove heat, high leakage inductance, low magnetizing inductance and limited numbers of turns. Some of these very factors—heat dissipation, magnetic coupling, leakage inductance and magnetizing inductance—are the very terms by which circuit designers define the efficiency and coupling of a transformer apparatus.

There is a need for a compact transformer apparatus having improved coupling that can be advantageously employed in compact electrical circuitry.

### SUMMARY OF THE INVENTION

An electrical transformer apparatus includes: (a) an electrically conductive hollow rod having a continuous via extending from a first end to a second end; (b) an elongate electrically conductive member traversing the via at least one time; and (c) at least one ferrous member substantially surrounding a portion of the rod.

It is, therefore, an object of the present invention to provide a compact transformer apparatus having improved coupling that can be advantageously employed in compact electrical circuitry.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic stylized transparent perspective illustration of the transformer of the present invention.

FIG. 2 is a plan view of the preferred embodiment of the transformer of the present invention.

FIG. 3 is a side view of the transformer illustrated in FIG. 2, taken in the direction indicated by arrows 3-3 in FIG. 2.

### DETAILED DESCRIPTION OF THE PREFERRED EMBODIMENT

The transformer apparatus of the present invention is a coaxial transformer constructed with a primary element wound within a hollow, electrically conductive rod structure. The hollow rod is employed as the transformer secondary element. Ferromagnetic core material is situated in surrounding relation about the secondary element. In its preferred embodiment, the ferromagnetic core material is provided in modular sections. Provision of modular sections for establishing the transformer core permits flexibility of design with a single part-combination of the apparatus. That is, a particular rod size may be used in constructing transformer apparatuses having a number of various combinations of different primary windings (i.e., different numbers of primary turns) and various combinations of ferrous segments arranged on the rod (secondary element) for establishing the transformer core. Such flexibility of design by variations with a finite number of discrete parts contributes to efficiencies in manufacture by keeping parts counts lower. A lower parts count is advantageous by involving in fewer tolerances to monitor, fewer inventory items to maintain, and fewer production scheduling variations to accommodate for a given number of products.

The coaxial design of the transformer apparatus of the present invention locates various components—primary element, secondary element and core—in a denser orientation than is available in planar magnetic transformer designs. Increased density of components contributes to improved transformer performance.

The configuration of the secondary element of the transformer apparatus of the present invention is tantamount to providing a very large secondary winding intimately in contact with the surrounding magnetic core. This arrangement contributes to improved heat transfer. Evacuating heat from a transformer contributes to improved performance reliability and longer transformer life.

Winding the primary element within the interior of the secondary element (hollow rod) further promotes improved electromagnetic coupling between the primary element and the secondary element, and also contributes to improved heat transfer. Keeping the walls of the hollow rod (secondary element) thin reduces occasions of eddy currents terminating on themselves, and thereby further reduces a source of heat within the apparatus.

The modular character of the ferromagnetic core configured in core segments permits additional flexibility in transformer design. The capability to provide various numbers of core segments for constructing the ferromagnetic core of the transformer permits flexibility in controlling flux density. Transformers may be designed for a variety of product applications with a single secondary element (hollow rod). For example, one may increase cross-section of the ferromagnetic core of a transformer to increase the power capacity of the transformer. The additional cross section will allow for a proportionally higher voltage swing on the primary element, thereby permitting higher power operation. Such an increase of cross section of core may be carried out in the transformer apparatus of the present invention merely by installing additional core segments (core modules) upon the secondary element. There is no need to increase the diameter of the core sections, which would negate the advantage of compact design sought for smaller products. One parts set—primary element, secondary element and core segments (in the desired number)—can meet several various product requirements.

Sharp terminations in a magnetic device, such as a transformer apparatus, provide loci for E-field losses. E-field losses may be manifested as radiated radio frequency (RF) noise. The transformer apparatus of the present invention provides an electrically “smooth” construction. The primary element is arranged in relatively wide loops. The secondary element has sharp terminations only at ends of the hollow rod. The hollow rod structure of the secondary element serves to completely shield the contained portion of the winding of the primary element.

The transformer apparatus of the present invention may be configured for surface mounting, for through-hole mounting or for accommodating other terminating technologies such as conductive epoxy termination or other terminations.

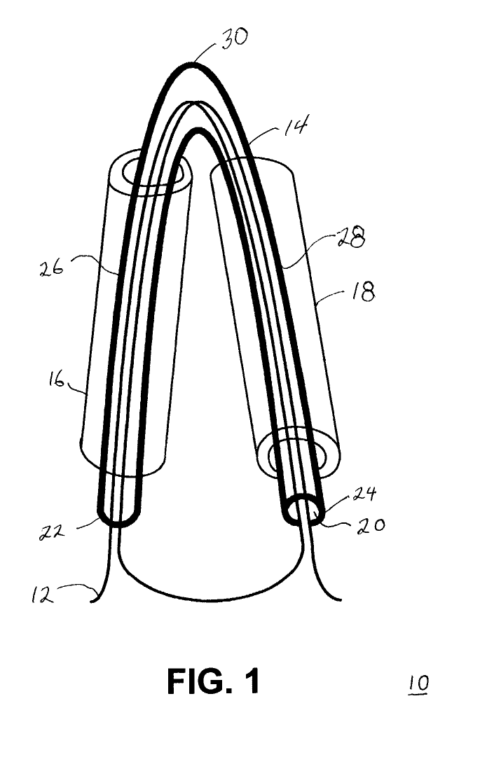

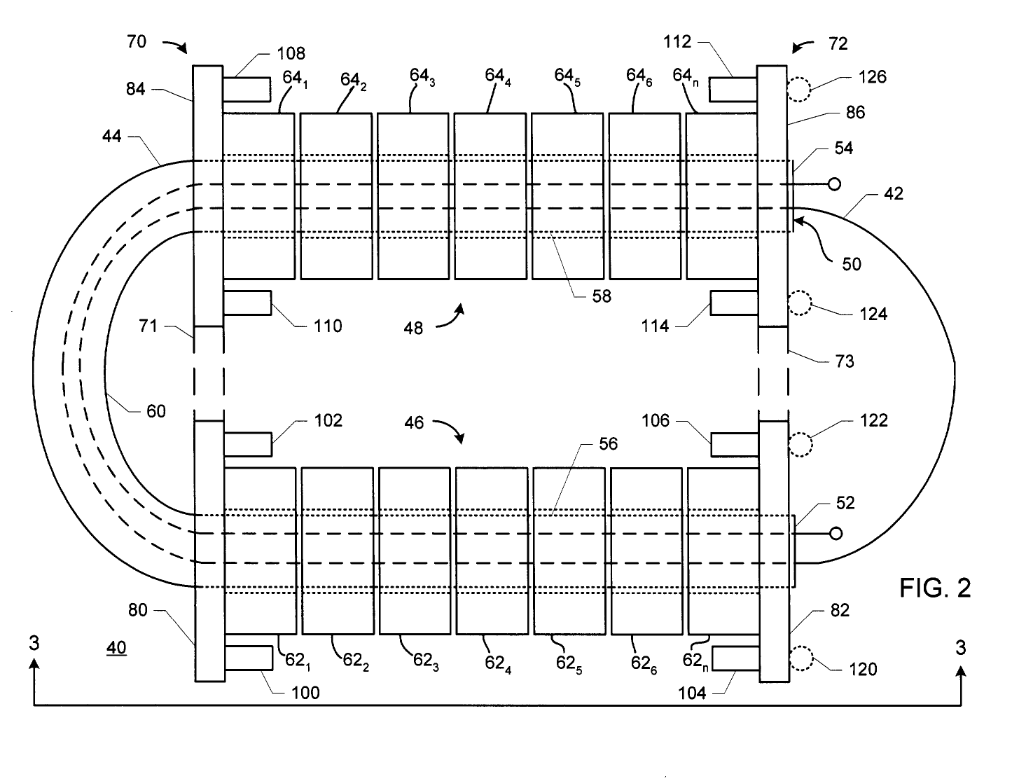

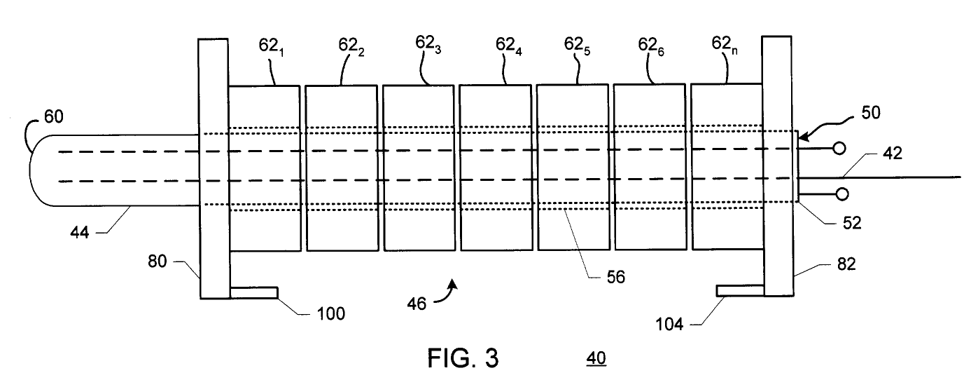

FIG. 1 is a schematic stylized transparent perspective illustration of the transformer of the present invention. In FIG. 1, an electrical transformer apparatus 10 includes a primary element 12, a secondary element 14, a first ferrous element 16 and a second ferrous element 18. Primary element 12 is preferably embodied in an electrically conductive elongate member, such as an electrical wire. Primary element 12 is preferably a copper wire with a surrounding insulator layer (not shown in detail in FIG. 1). Secondary element 14 is embodied in a hollow rod-like structure, preferably a copper tube, having a via 20 traversing secondary element 14 from a first end 22 to a second end 24. Secondary element 14 is preferably fashioned having a first leg 26, a second leg 28 and a bight portion 30 joining first leg 26 and second leg 28. The preferred embodiment of secondary element 14 is in a U-shape with first leg 26 and second leg 28 in a substantially coplanar parallel relationship (see FIGS. 2 and 3).

Ferrous elements 16, 18 are preferably embodied in ferromagnetic material situated in substantially closely surrounding relationship about legs 26, 28 of secondary element 14. Ferrous elements 16, 18 operate as a ferromagnetic core element for transformer apparatus 10. As will be described in connection with FIGS. 2 and 3, ferrous elements 16, 18 are preferably configured in ferrous segments so that a varied amount of core cross-section may easily be effected in transformer apparatus 10 for various product applications using a single part-type or size of secondary element 14.

Primary element 12 is installed in windings traversing via 20 between ends 22, 24 of secondary element 14. The number of times that primary element 12 traverses via 20 determines certain operating characteristics of transformer apparatus 10, such as turns ratio. Primary element 12 may be wound any number of times through via 20 so that a varied amount of operating characteristics may easily be effected in transformer apparatus 10 using the same part-type or size of secondary element 14.

FIG. 2 is a plan view of the preferred embodiment of the transformer of the present invention. In FIG. 2, an electrical transformer apparatus 40 includes a primary element 42, a secondary element 44, a first ferrous element 46 and a second ferrous element 48. Primary element 42 is preferably embodied in an electrically conductive elongate member, such as an electrical wire. Primary element 42 is preferably a copper wire with a surrounding insulator layer (not shown in detail in FIG. 2). Secondary element 44 is embodied in a hollow rod-like structure, preferably a copper tube, having a via 50 traversing secondary element 44 from a first end 52 to a second end 54. Secondary element 44 is preferably fashioned having a first leg 56, a second leg 58 and a bight portion 60 joining first leg 56 and second leg 58. The preferred embodiment of secondary element 44 is in a U-shape with first leg 56 and second leg 58 in a substantially coplanar parallel relationship.

Ferrous elements 46, 48 are preferably embodied in ferromagnetic material situated in substantially closely surrounding relationship about legs 56, 58 of secondary element 44. Ferrous elements 46, 48 operate as a ferromagnetic core element for transformer apparatus 40. First ferrous element 46 includes ferrous segments 62₁, 62₂, 62₃, 62₄, 62₅, 62₆, 62ₙ. Second ferrous element 48 includes ferrous segments 64₁, 64₂, 64₃, 64₄, 64₅, 64₆, 64ₙ. The subscript “n” indicates that there is no theoretical limit to the number of ferrous segments 62ₙ, 64ₙ that may be employed with transformer apparatus 40. Ferrous segments 62ₙ, 64ₙ permit a varied amount of core cross-section to be easily effected in transformer apparatus 40 for various product applications using a single part-type or size of secondary element 44.

Primary element 12 is installed in windings traversing via 50 between ends 52, 54 of secondary element 44. The number of times that primary element 42 traverses via 50 determines certain operating characteristics of transformer apparatus 40, such as step-down ratio. Primary element 42 may be wound any number of times through via 50 so that a varied amount of operating characteristics may easily be effected in transformer apparatus 40 using the same part-type or size of secondary element 54.

Transformer apparatus 40 includes support members 70, 72. Support members 70, 72 connect first leg 56 and second leg 58 in a rigid structure contributing to a robust construction for transformer apparatus 40. Support members 70, 72 may each be a single structure, as indicated by dotted lines 71, 73. Alternatively, support members 70, 72 may be fashioned as individual support structures 80, 82, 84, 86. In such an embodiment, support structures 80, 82 support first leg 56 and support structures 84, 86 support second leg 58. Support structures 80, 82 may contribute to properly maintaining ferrous segments 62ₙ in place on first leg 56. Support structures 84, 86 may contribute to properly maintaining ferrous segments 64ₙ in place on second leg 58. When fewer ferrous segments are employed in a particular product version of transformer apparatus 40, one or more non-ferrous spacer structure may be placed between support structures 80, 82 or between support structures 84, 86 (or between both pairs of support structures) to assist pairs of support structures 80, 82 and 84, 86 in limiting movement of ferrous segments 62ₙ, 64ₙ along legs 56, 58 of secondary element 44. Non-ferrous spacer structures preferably are physically dimensioned similarly to dimensions of ferrous segments 62ₙ, 64ₙ.

Contact structures 100, 102 may effect electrical contact with support structure 80. Contact structures 104, 106 may effect electrical contact with support structure 82. Contact structures 108, 110 may effect electrical contact with support structure 84. Contact structures 112, 114 may effect electrical contact with support structure 86. Electrical connection may be established through at least some of contact structures 100, 102, 104, 106, 108, 110, 112, 114 with an electrical circuit arrayed upon a printed circuit board or similar substrate using contact pads provided in circuit traces on the substrate (not shown in FIG. 2). Electrical connection may be effected using surface mount techniques including wave soldering, vapor phase reflow soldering, conductive epoxy or another connection technology. A non-electrically connected support structure 100, 102, 104, 106, 108, 110, 112, 114 can be eliminated or can be left installed in a particular transformer apparatus 40 for contributing to physical support for the particular transformer apparatus 40. Other alternate connection structures 120, 122, 124, 126 (shown in dotted lines to emphasize their alternate nature) may be provided affixed with selected support structures, such as support structures 82, 86, for accommodating other electrical connection techniques, such as through-hole connection.

FIG. 3 is a side view of the transformer illustrated in FIG. 2, taken in the direction indicated by arrows 3-3 in FIG. 2. In FIG. 3, one-half of electrical transformer apparatus 40 is masked so that elements associated with first leg 56 of secondary element 44 are visible, and elements associated with second leg 58 are not visible. This is because transformer apparatus 40 is constructed according to the preferred embodiment of the invention with legs 56, 58 in substantially coplanar parallel relationship. Thus, first ferrous element 46 includes ferrous segments 62₁, 62₂, 62₃, 62₄, 62₅, 62₆, 62ₙ. Ferrous segments 62ₙ permit a varied amount of core cross-section to be easily effected in transformer apparatus 40 for various product applications using a single part-type or size of secondary element 44.

Primary element 12 is installed in windings traversing via 50 between ends 52, 54 of secondary element 44 (only end 52 is visible in FIG. 3). The number of times that primary element 42 traverses via 50 determines certain operating characteristics of transformer apparatus 40, such as step-down ratio. Primary element 42 may be wound any number of times through via 50 so that a varied amount of operating characteristics may easily be effected in transformer apparatus 40 using the same part-type or size of secondary element 54.

Support structures 80, 82 are visible in FIG. 3 in supporting relationship with first leg 56 of secondary element 44. Support structures 80, 82 may contribute to properly maintaining ferrous segments 62ₙ in place on first leg 56. Contact structure 100 may effect electrical contact with support structure 80. Contact structures 104 may effect electrical contact with support structure 82. Electrical connection may be established through contact structures 100, 104 or with one or more other contact structures 102, 106, 108, 110, 112, 114 (FIG. 2) with an electrical circuit arrayed upon a printed circuit board or similar substrate using contact pads provided in circuit traces on the substrate (not shown in FIG. 3). Electrical connection may be effected using surface mount techniques including wave soldering, vapor phase reflow soldering, conductive epoxy or another connection technology. Other alternate connection structures 120, 122, 124, 126 (shown in FIG. 2) are not included in FIG. 3.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An electrical transformer apparatus comprising:
(a) a primary element;
(b) a secondary element; said second element being substantially rod-shaped along a length; said second element presenting a via substantially along said length; said via substantially containing said first element; and
(c) a ferrous element; said ferrous element substantially surrounding at least a portion of said secondary element.

2. An electrical transformer apparatus as recited in claim 1 wherein said secondary element includes a first leg, a second leg and a bight portion joining said first leg and said second leg.

3. An electrical transformer apparatus as recited in claim 1 wherein said primary element is an elongate conductive structure; said primary element traversing said via at least one time.

4. An electrical transformer apparatus as recited in claim 2 wherein said primary element is an elongate conductive structure; said primary element traversing said via at least one time.

5. An electrical transformer apparatus as recited in claim 1 wherein said ferrous element includes a plurality of ferrous members; said plurality of ferrous members being affixed in generally adjacent relationship in said substantially surrounding at least a portion of said secondary element.

6. An electrical transformer apparatus as recited in claim 2 wherein said ferrous element includes a plurality of ferrous members; first selected ferrous members of said plurality of ferrous members being affixed in generally adjacent relationship in said surrounding relationship along said first leg; second selected ferrous members of said plurality of ferrous members being affixed in generally adjacent relationship in said surrounding relationship along said second leg.

7. An electrical transformer apparatus as recited in claim 5 wherein said primary element is an elongate conductive structure; said primary element traversing said via at least one time.

8. An electrical transformer apparatus as recited in claim 6 wherein said primary element is an elongate conductive structure; said primary element traversing said via at least one time.

9. An electrical transformer apparatus comprising:
(a) an electrically conductive hollow rod having a continuous via extending from a first end to a second end;
(b) an elongate electrically conductive member; said elongate conductive member traversing said via at least one time; and
(c) at least one ferrous member substantially surrounding a portion of said rod.

10. An electrical transformer apparatus as recited in claim 9 wherein said rod includes a first leg extending from said first end to a first intermediate locus, a second leg extending from said second end to a second intermediate locus and a bight member connecting said first intermediate locus and said second intermediate locus.

11. An electrical transformer apparatus as recited in claim 10 wherein said first leg and said second leg are substantially parallel in a plane.

12. An electrical transformer apparatus as recited in claim 9 wherein said at least one ferrous member is a plurality of ferrous members affixed in generally adjacent relationship substantially surrounding at least one of said first leg and said second leg.

13. An electrical transformer apparatus as recited in claim 10 wherein said at least one ferrous member is a plurality of ferrous members affixed in generally adjacent relationship substantially surrounding at least one of said first leg and said second leg.

14. An electrical transformer apparatus as recited in claim 11 wherein said at least one ferrous member is a plurality of ferrous members affixed in generally adjacent relationship substantially surrounding at least one of said first leg and said second leg.

15. An electrical transformer apparatus as recited in claim 9 wherein said elongate conductive member is a wire; said wire traversing said via a plurality of times and presenting two wire ends for effecting electrical connection with a circuit.

16. An electrical transformer apparatus as recited in claim 12 wherein said elongate conductive member is a wire; said wire traversing said via a plurality of times and presenting two wire ends for effecting electrical connection with a circuit.

17. An electrical transformer apparatus as recited in claim 13 wherein said elongate conductive member is a wire; said wire traversing said via a plurality of times and presenting two wire ends for effecting electrical connection with a circuit.

18. An electrical transformer apparatus as recited in claim 14 wherein said elongate conductive member is a wire; said wire traversing said via a plurality of times and presenting two wire ends for effecting electrical connection with a circuit.
